(19) United States
(12) Patent Application Publication
(10) Pub. No.: US 2003/0172044 A1
(43) Pub. Date: Sep. 11, 2003

(54) Configuration-dependent download process

(76) Inventor: Andrew Divaker ShamRao, Chicago, IL (US)

Correspondence Address: Andrew Divaker ShamRao, 2901 S. Michigan Ave., Suite 1703, Chicago, IL, 60616, US

(21) Appl. No.: 09/992,113

(22) Filed: Nov. 6, 2001

(51) Int. Cl. G06F 7/00

(52) U.S. Cl. 707/1

(57) ABSTRACT

A method for downloading data from a server to a computer, which includes accessing user preferences; transmitting user preference and computer configuration information to the server; determining applications that can be supported by the computer configuration; and downloading only supported applications to the computer.

This application is related to Ser. No. ______ entitled “COMMUNICATION PROCESS FOR RETRIEVING INFORMATION FOR A COMPUTER”,Ser. No. ______ entitled “SYSTEMS AND METHODS FOR ENSURING SECURITY AND CONVENIENCE”, and Ser. No. ______ entitled “HANDHELD COMPUTER SYSTEMS AND METHODS”, all of which share common inventorship and filed on the same date, the contents of which are hereby expressly incorporated-by-reference.

### BACKGROUND

The present invention relates generally to systems and methods for downloading data from a server to a computer.

Handheld computing is a recent phenomenon and these computing devices include everything from pagers, to palm devices, to cell phones. The features carried by these devices are converging and include compactness, portability, expandability, data reception, transmission, input, and display. The handheld computing and communications industry is growing rapidly as users, particularly mobile professionals, increasingly rely on electronic management of critical personal and professional information, interaction with Internet-based information resources and mobile voice and data communications. Handheld devices such as personal digital assistants (PDAs) are small, handheld computers primarily used to write notes, record names, addresses and phone numbers, to develop an appointment calendar, and otherwise keep appointments in order. A scheduling program running separately in each of the computer and the handheld computer maintains separate database information in data files relating to scheduled appointments and contact information.

These handheld computers often rely on the use of a stylus for data entry. The two most common methods for data entry utilizing a stylus are 1) tapping on an “on-screen software keyboard” and 2) hand writing on a pressure-sensitive layer. In the first method the electronic device displays a keyboard, buttons, or other indicia on a pressure sensitive screen, and the user selects the desired option by tapping an appropriate location with the stylus. In the second method the user moves the stylus across a pressure-sensitive surface to form characters. In this latter method, known as “handwriting recognition,” the device recognizes the characters formed by the user on the pressure-sensitive surface. Exemplary handheld devices include products from Palm Computing, Handspring, and Windows-CE based handheld computers.

One growth driver for handheld devices is wireless communications that enable compelling applications. Digital wireless communications have become widely adopted due to declining consumer costs, expanding network coverage and the availability of extended service features such as voice and text messaging. Digital wireless technologies, which are currently designed for voice transmission and allow only limited data transmission capabilities, are evolving towards advanced technologies enabling higher data transmission rates at lower costs. Further, the development of applications for the digital delivery of consumer products and services, such as photographs, music, video games, news, books, driving directions, weather and stock quotes and trading, has accelerated as physical products and services are increasingly being replaced with bytes of data that are wirelessly transmitted.

These trends are accelerating toward the emergence of a device that integrates handheld computing applications and a broad range of communications functions. The recent push in the industry has been to create devices that can access the Internet wirelessly and allow the user to interact in a meaningful way with the information obtained from the Internet. Much of the effort has been directed at enhancing and using cellular technology to allow for communication with the Internet. This form of communication is still in its infancy, primarily because of the absence of universal standards in the mobile technology field, and the absence of bandwidth

Current handheld products provide consumers with limited choices, typically between a simple device without expandability or the ability to be upgraded, and a complex, multi-function device that is expensive, awkward to handle with modular attachments and difficult to use. Current devices are limited on a number of different levels. (1) Components of a device cannot be upgraded. (2) Existing devices do not possess an “open” architecture to facilitate standards in the industry and mass application development. Current handheld mobile devices initially are constructed to port proprietary software. (3) Owners of existing devices are “slaves” to their devices because of their monetary value, and because of security concerns. Much of their personal information may be stored on the device and therefore, the device becomes indispensable. While the price of these devices is decreasing steadily, it is still beyond the reach of most consumers. (4) Existing devices do not integrate functionality of PDAs and cellular and Internet telephony. One device on the market, which is not upgradeable, requires the user to purchase expensive modular attachments to make use of enhanced features. The only other alternative users have, to gain access to new features, is to purchase a new device that ports them, or allows modular attachments to achieve that end. Also, current devices and trends in the farther development of them are slaves to cellular technology for communication with the Internet to conduct online wireless transactions. At this point in the infancy of wireless communication, it is inconclusive whether cellular technology or local-server technology is better.

### SUMMARY

In one aspect, a method for downloading data from a server to a computer includes accessing user preferences from a Personal Universal Memory (PUM) card; transmitting user preference and computer configuration information to the server; determining applications that can be supported by the computer configuration; and downloading only supported applications to the computer.

Implementations of the above aspect may include one or more of the following. A code can be assigned to the application when a vendor subscribes to the service for hosting the application on the local server. One or more applications can be selected when the user configures the user preference. The codes for the selected applications can be stored on the PUM card or on a data storage device. Upon turning on the computer, the user can be authenticated. For example, a biometric scan can be performed to identify the user. A match between a scanned image and a user identifiable image stored on the PUM card can be verified. The method can request a user-identification and a password. The method can also check the user's preferences on the PUM card to identify applications to be downloaded during startup. The method can send a packet from the computer to the local server including: codes identifying the computer configuration; and codes identifying user-preferred applications. Codes of applications and application components on the server that match the codes for user-preferred applications sent by the computer can be requested. The codes of applications and application components on the server can also match the codes for non-supported user-preferred applications sent by the computer. Information about the computer configuration necessary to support the applications and application components can be requested. Additionally, the method includes requesting codes of applications and application components on the server that are supported by the computer's configuration. The user can be notified that one or more requested applications cannot be supported without up grading the computer hardware, and can be informed what upgrades are necessary to support the applications. Further, the user can be provided with options to abort the download or to select applications supported by the computer for download. Items selected by the user can be downloaded if the user opts to download supported applications and application components. Data being downloaded to the computer can be scanned with anti-virus software. The anti-virus software can be automatically updated upon initial connection with the server. The computer can be selected from one of the following: a wired device, a wireless device, a personal digital assistant, a handheld computer, a laptop computer and a cellar telephone.

In another aspect, a method for downloading data from a server to a computer includes accessing user preferences, transmitting user preference and computer configuration information to the server; determining applications that can be supported by the computer configuration; and downloading only supported applications to the computer.

Advantages of the invention may include one or more of the following. A compact, portable, wireless communication device (“device”) allows the user to receive data from a local area server and transmit data to a local area server wirelessly. The device also acts as an audio and text input device to promote the user's interaction with content that has been received from the server and to facilitate text and audio messaging. Input can occur using a keyboard on the device's touch-sensitive screen, or by voice,

With this device, the user can set shopping list preferences to receive preference-based advertisements from local area vendors (e.g., in a mall), download games and other applications through communication with a local server (e.g., for use during wait time . . . or as a child-sitting device), record audio messages or convert audio input to a text file, access and surf the internet, email eCards, text files, audio files, download songs, access profile and preference information from a remote server, update their personal profile and preference information on their device, or on a remote server, create a new profile and preference fie on the device, make telephone calls, make online payments for products and services at the vendor site, upgrade various components as needed to be able to use applications or advanced features of the device, personalize the look of the device with different “faces,” and share the device with others without compromising security. The device's use of a local area network allows for vendor to have local storage and access to their data and marketing campaigns accessed by device users.

Other advantages of the invention may include one or more of the following. The device is a wireless PDA that is small, elegant and easy to use, yet flexible enough to support a wide variety of personal preferences and professional requirements. The system provides a “generic,” “open” architecture to facilitate a standard for writing wireless applications. The device is scalable, customizable, integrative, with disposable components.

The device is scalable because its components can be upgraded to handle more sophisticated web-based applications and features than the most basic version of the device can support. It is customizable because its components can be configured to suit the needs of the user. The device components are disposable because by themselves, they will be relatively inexpensive. The value of the device is determined by the sum of its components. The components are salvageable, so if one part is dysfunctional, it can be disposed of and replaced or upgraded.

Another advantage of the device is that it is integrative because it combines functions of a Personal Digital Assistant (e.g., The Palm; see www.palm.com), with that of a messaging/email device (e.g., The BlackBerry, see www.blackberry.net), with that of phones using Internet Telephony (e.g., Iconnecthere and Net2PhoneDirect; see www.Iconnecthere.com and www.Net2phonedirect.com). Telephony is achieved by wirelessly communicating with the Internet through a local area server. Thus, the device provides independence from cellular telephone technology in that the device can do ever a cell phone can do without using cellular technology. However, because the device is component driven, the components can be changed and reconfigured to accommodate cellular technology when necessary.

Currently owners are “slaves” to their mobile devices because of the monetary value of the device, because all of their information is stored on the device, and because of security issues. This device liberates the user because it is designed to be “slave” to the user.

As indicated above, because of its removable, replaceable, and upgradeable component-based architecture, the cost of this device is manageable and therefore, the device itself is virtually disposable. This device also does not permanently house critical user information, and therefore is disposable for this reason as well, and is useable by multiple users in sequence. Critical user information is stored on a removable, replaceable, and upgradeable Personal Universal Memory Card (PUM Card), the size of a credit card that this device will accept. Third, three critical processes ensure the privacy and security of user information while a user is operating the device.

Thus, the device is user-dependent and will be “slave” to the user whose Personal Universal Memory Card is inserted into it. The three processes that ensure the privacy and security of user information are the Biometric Identity Scanning Process, coupled with a request for user identification and password, for authenticating that the user is the owner of the PUM Card inserted into the device, the Private Communication Process for ensuring secure transactions with the servers and other devices, and the Smart-Erase Shutdown Process for ensuring that the contents of a PUM Card left in a device are erased so its contents are not accessible by hackers.

Another advantage of the device is that it contains a Configuration-Dependent Download Process that ensures efficient operation of the device. An application will only be downloaded to a device if the device's configuration matches those required by the application for efficient operation on the device.

Various other features and advantages will appear from the description to follow. In the description, reference is made to the accompanying drawings that form a part thereof and in which is shown by way of illustration, a specific embodiment for practicing the invention. This embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings wherein like reference numerals represent like parts:

FIGS. 1A, 1B,1C and 1D show a front view, a side view, a bottom view and a rear view of an exemplary handheld device, respectively.

FIG. 2 shows an exemplary process executed when information is being downloaded to the device of FIGS. 1A-1D.

FIG. 3 shows a process to perform voice input.

FIG. 4A shows an exemplary process executed when information is being “pulled” from a server.

FIG. 4B shows an exemplary process executed when information is being “pushed” to a server.

FIG. 5 illustrates an exemplary process to update user profile and preferences.

FIG. 6 shows an exemplary process executed during shut down of the device of FIGS. 1A-1D.

FIG. 7 show a front view and a rear view of an exemplary Personal Universal Memory Card (PUM Card).

FIG. 8 shows an exemplar network supporting the wireless device of FIGS. 1A-1D

### DESCRIPTION

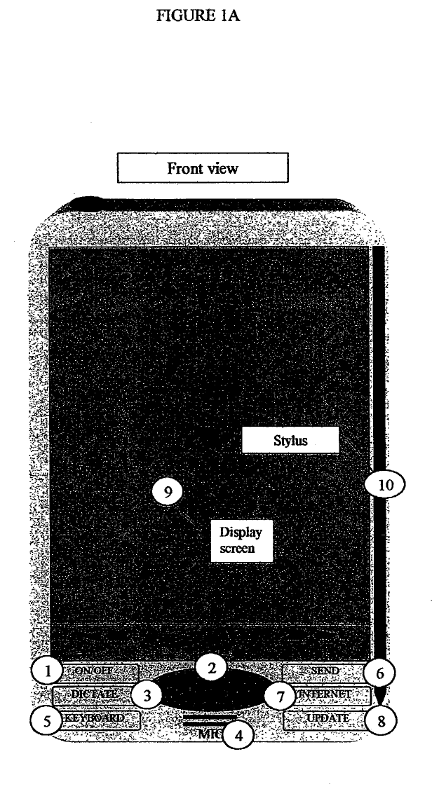

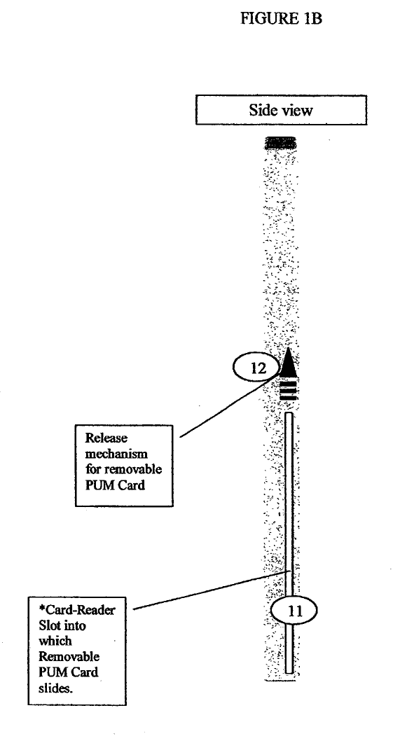

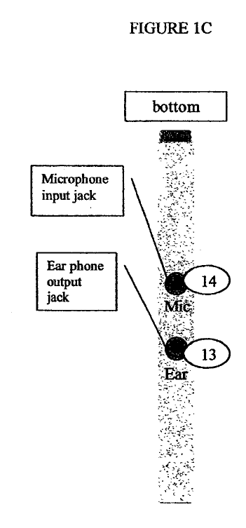

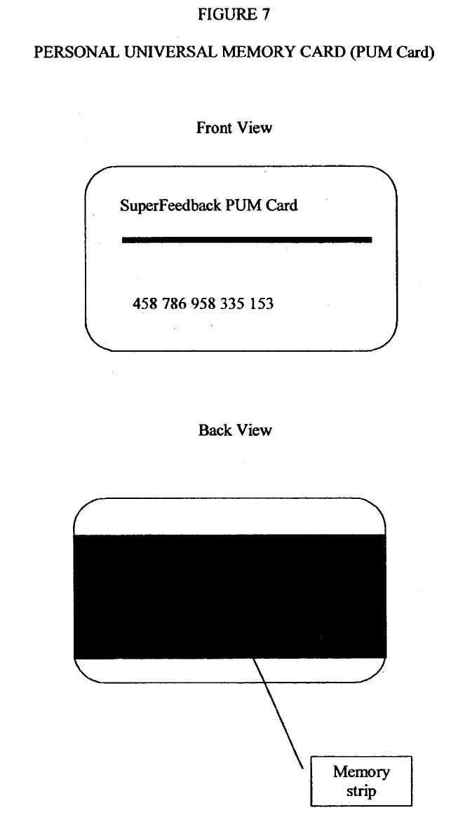

FIGS. 1A, 1B and 1C show a front view, a side view and a bottom view, respectively, of an exemplary compact, portable wireless, handheld communication device (“device”). FIG. 1A shows the plurality of buttons on the device, including an “ON/OFF” button 1, a “DICTATE” button 3, a “KEYBOARD” button 5, a “SEND” button 6, an “INTERNET” button 7, and an “UPDATE” button 8. The device also provides a display screen 9. The device also includes a microphone port 4 and a speaker port 2. As shown in FIGS. 1A, a stylus 10 is slidably stored in a recess along the right side of the device facing the user. FIG. 1B shows a card-reader slot 11 into which the Personal Universal Memory Card (PUM Card) 15 (See FIG. 1D and FIG. 7) slides. Above the PUM Card slot is a release mechanism 12 for releasing the card. The PUM card is credit card sized and is used for storing user-produced information, such as profile information, preference information, e-mails, addresses, lists, calendar information, and so on. FIG. 1C shows an earphone plug 13 and a microphone plug 14 to receive an external earphone and/or an external microphone.

The device's value as a means of personalizing one's online and offline shopping experience is realized only when a Personalized Universal Memory Card (PUM Card) 15 is inserted into the PUM Card slot 11 on the side of the device. The user can insert the PUM Card either in a rented device, a borrowed device, or one the user owns. Once the card is inserted, and the user presses the “ON/OFF” button 1, the device powers up, and activates the antenna 24 (see FIG. 1D), which facilitates wireless communication with a local server. At this point, the device prompts the user, for example, to place his index finger on the Biometric Identity Scanner 16 (See FIG. 1D. Also see www.keytronic.com for a sample scanner embedded in a laptop), which matches the user's digitalized fingerprint with one stored on the PUM Card. If there is a match, the user is informed that he has been identified as the owner of the PUM Card and, therefore, can use it. At this point, the device proceeds to personalize the device based on the user preferences stored on the PUM Card.

In one implementation, the card reader in the slot 11 is an internal unit mounted in a recess in the handheld computer. The reader receives the PUM card and electrical contacts on the reader connects electrical fingers that are accessible on the PUM card. The electrical fingers support address bus signals, data bus signals, control bus signals, ground and power signals. These signals are communicated over the electrical fingers so that the processor of the handheld device can access memory or another processor mounted in the handheld computer.

Alternatively, in another implementation, an external reader can be used to read the PUM cards. The external reader is a small device that communicates with the handheld computer over a communication port such as the serial bus. The user then plugs the card into this and it is then directly accessible by the handheld device.

In yet another implementation, the reader can also be a magnetic stripe reader for reading data encoded onto a magnetic strip on the PUM card. In one embodiment, the technique used for encoding magnetic cards is a “Two-Frequency, Coherent Phase Recording” that allows for the representation of single-channel, self-clocking serial data (F/2F). The reader can be motorized to move magnetic cards or can rely on manually moving the card, either through a slotted reader or into an insertion-type reader.

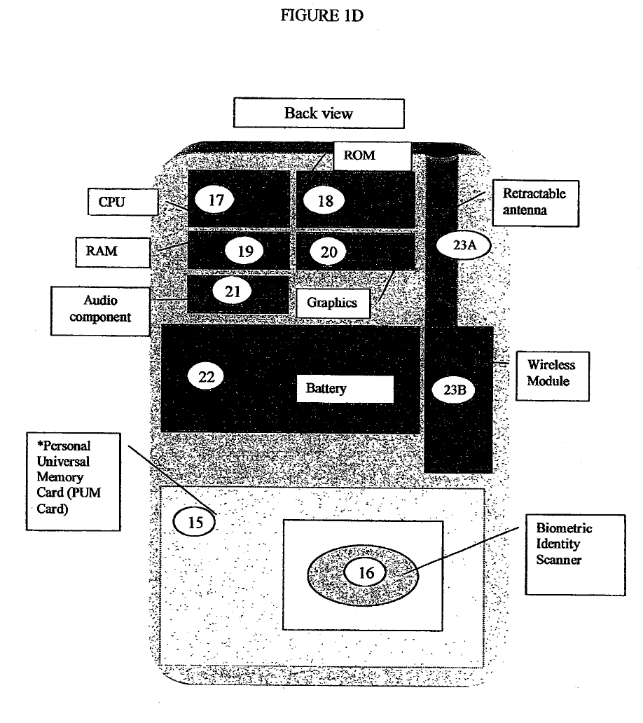

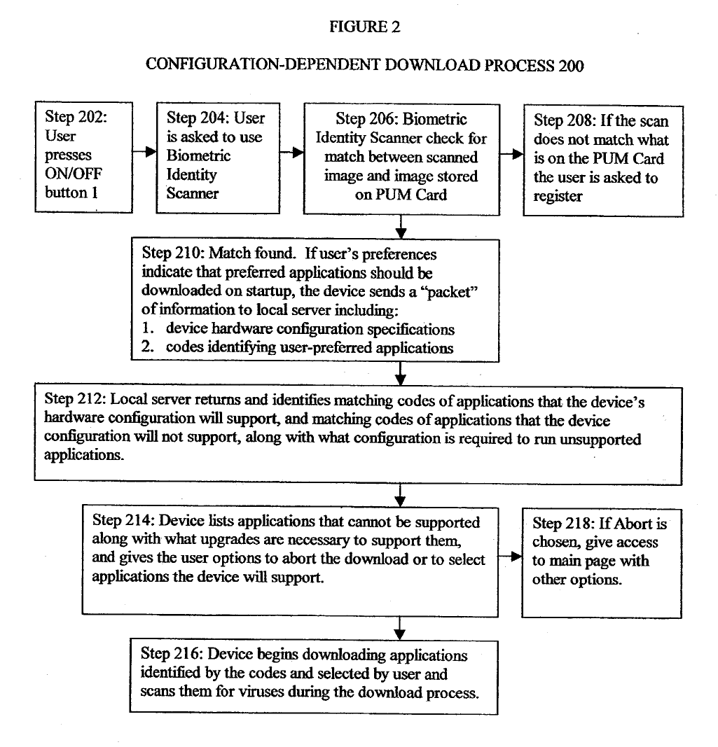

One set of preferences stored on the device is for applications the user likes to use on the device. FIG. 2 describes an exemplary process 200, called the Configuration-Dependent Download Process, used by the device to download user-preferred applications from the server, while maintaining the efficiency of the device. An application will only be downloaded to a device if its configuration matches those required by the application, so as to ensure efficient operation of the device. Additional items that are downloaded include any text or audio messages sent to the user. The text messages can be viewed on the display screen 9, and the audio messages can be heard either on the speaker located at the speaker port 2, or using an earphone plugged into the earphone plug 13.

The Configuration-Dependent Download Process 200 is executed when the device is powered on. First, the user presses the on/off button (step 202). Next, the process 200 requests the users to use the Biometric Identity Scanner to authenticate his ownership of the PUM Card in device (step 204). In step 206, the Biometric Identity Scanner checks for a match between the scanned image and the one stored on the PUM Card. If the scan does not match what is on the PUM Card, the user is asked to register (step 208). If a match is found, and the user's preferences indicate that preferred applications should be downloaded on startup, the device will send a “packet” of information to the local server including the device hardware configuration specifications, and the codes identifying user-preferred applications (step 210). The local server will look for applications whose codes match the codes for user-preferred applications; It will then see if the hardware specification requirements for these applications match the hardware configuration of the device. When the codes and configuration requirements match, the server will return only the codes for applications that the device's hardware configuration will support (step 212). In step 214, the device informs the user if some applications cannot be supported, and gives the user options to abort the download or to select from among the applications the device will support. If the user opts to download applications, then the device commences the download process (step 216). If the user chooses to abort the download process, the user is given access to the main screen where he can select other options (step 218).

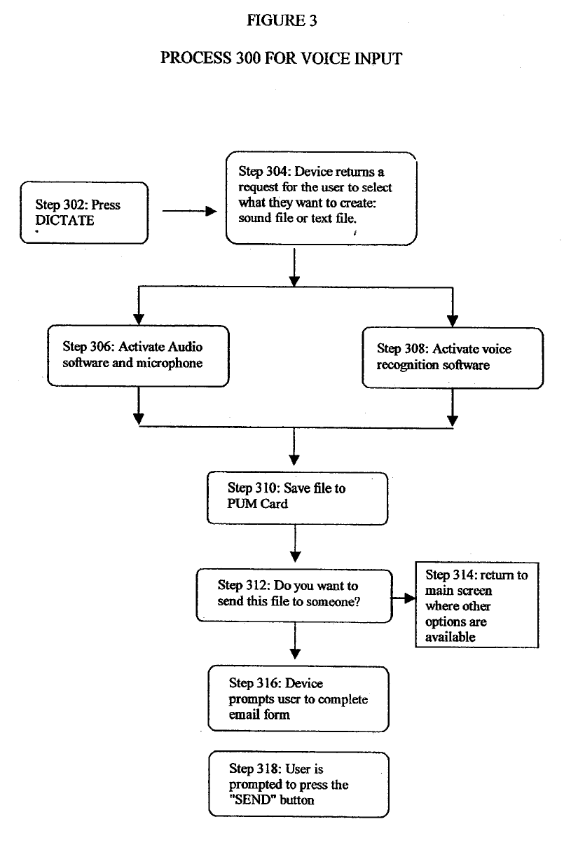

The device also allows for one-touch data input through voice transmission by means of pressing a button such as the “DICTATE” button 3. The process 300 for voice data input is shown in FIG. 3. Pressing the “DICTATE” button (step 302) causes the device to ask the user whether he wants to create a text file or a sound file (step 304) and to execute either the audio-capture software and microphone housed in port 4 (step 306), or speech recognition software (step 308), depending on the user's choice. The audio or text file that was created is saved on the PUM card (step 310). Next, the device asks whether the user wishes to send the saved file (step 312). If “no” the user is returned to the main screen where other options may be selected (step 314). If the user opts to do so, the device prompts the him to complete an email form (step 316) and to press the “SEND” button 6 upon completion of the form to send the requested file (step 318).

Pressing the “KEYBOARD” button 5, causes the device to launch a mini keyboard at the bottom of the touch-sensitive display 9. The key inputs can be activated with the stylus 10 used to push on the touch sensitive display screen 9. The keyboard can be used to create email text or to select preferences, create shopping lists, give feedback on a feedback form and so on. After completing each of these activities, pressing the “SEND” button 6 initiates transmission of the information to the server.

One-touch Internet access is supported through the local area server by means of pressing a button such as the “INTERNET” button 7. Pressing this button causes the device to execute communication with the Internet through a local area server. The home page loaded onto the user's device can be their custom page if they have one, or a default home page. The user will be able to surf elsewhere from that point.

Once on the Internet, the user will be able to download games, songs and other applications, send eCards, check stocks, find maps, participate in auctions, reserve travel and entertainment tickets, and access personal profile and preference information, among other activities.

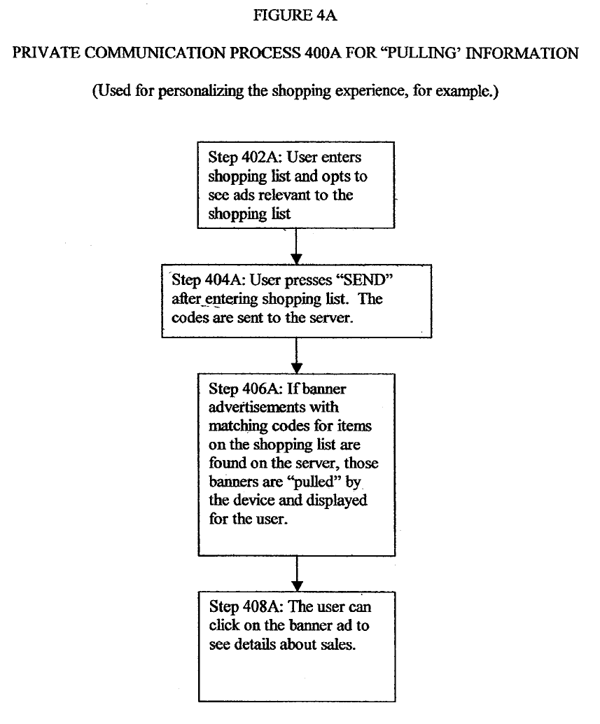

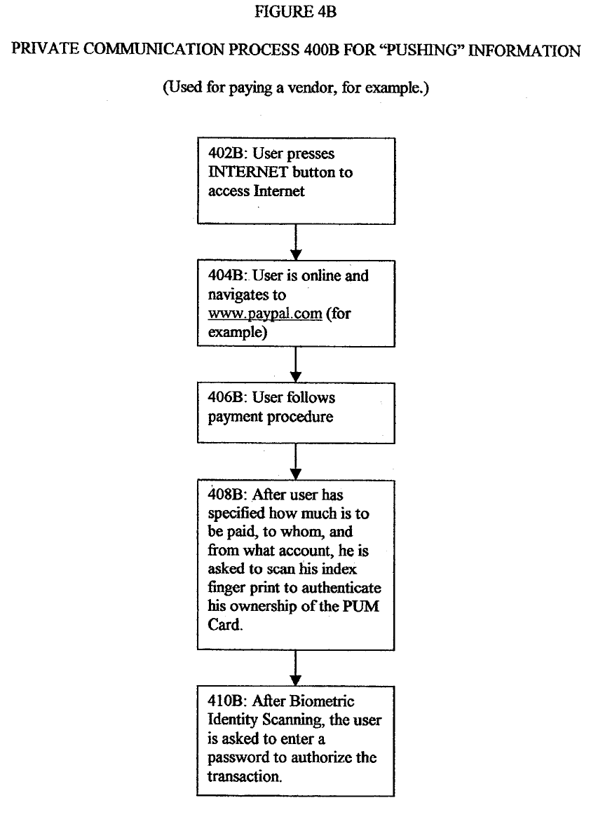

The device can be used to “pull” information from a server or other device or “push” information to a server or other device over the local network or over the Internet. The process that governs information sharing from the device is called The Private Communication Process. The Private Communication Process For “Pulling” Information uses codes to identify specific kinds of information. This process is described in FIG. 4A.

The Private Communication Process For “Pulling” Information is applicable, for example, when the user wants to see advertisements relevant to his shopping list. When the user enters his shopping list (step 402A), each item is coded in a standardized manner, for example, shirts will have a specific code. The codes are sent to the server when the user presses the “SEND” button (step 404A). If a banner advertisement with a matching code for shirts is found on the server, that banner is “pulled” by the device and displayed for the user (step 406A). At this point, the user can access more information by clicking on the banner ad (step 408A). By using the matching-code process, the user's privacy is protected because no personal information is shared about the user, and at the same time, the user is allowed to customize his shopping experience.

The Private Communication Process For “Pushing” Information is typically used when conducting a transaction to pay for a product or service online, or when interacting with an ATM machine, or some other device. The Private Communication Process For Online Payments is described in FIG. 4B. The user accesses the Internet by pressing the “INTERNET” button (step 402B). He navigates to a transaction site such as www.paypal.com (step 404B) and follows the site's payment procedure (step 406B). After specifying how much is to be paid, to whom, and from what account, the user is asked to authenticate that he is the owner of the PUM Card in the device by using the Biometric Identity Scanner (step 408B). Once authenticated, the user is asked to provide his password as permission to “push” personal information to a vendor from whom a product or service is being purchased (step 410B).

Besides performing transactions, the device can also be used to do Internet telephony. The sound capability supports the ability to converse with others as in a telephone call by connecting to the internet and accessing internet telephony vendors like www.net2phonedirect.com or www.iconnecthere.com.

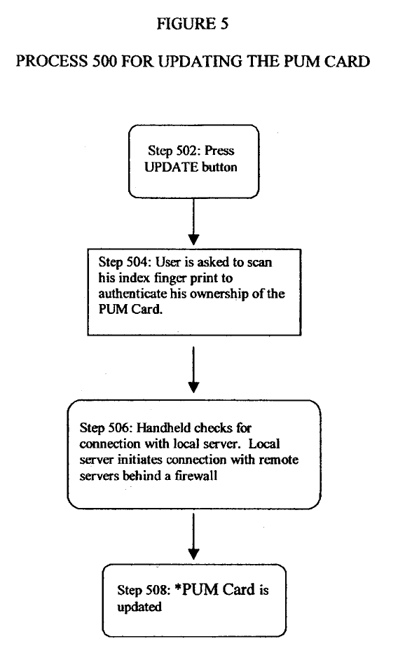

With respect to the“UPDATE” button 8, pressing this button causes the device to execute communication with the remote servers through the local server and to download the personal profile and preference settings for the user to the PUM card on the wireless device. This process is illustrated in FIG. 5.

First, the user requests the update by pressing an “UPDATE” button (step 502). Next, the user is asked to authenticate that he is the owner of the PUM Card in the device by using the Biometric Identity Scanner (step 504). In step 3, the device checks for a connection with the local server, and in response, the local server connects with the remote server behind a firewall (step 506). If the user authentication is successful, the PUM card is updated (step 508).

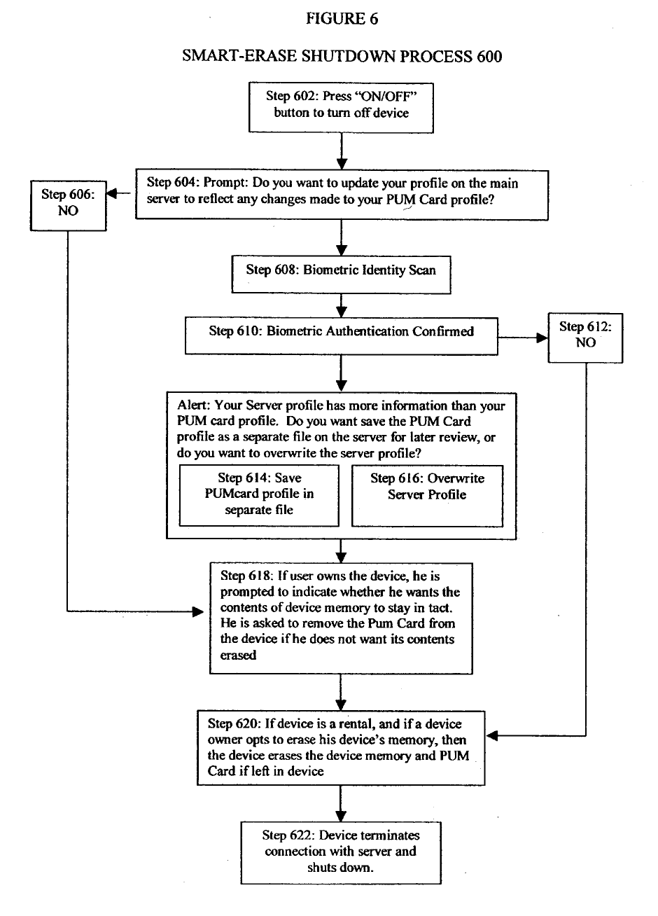

Pressing the “ON/OFF” button 1 at the end of a user session will initiate the Smart-Erase Shutdown Process 600 shown in FIG. 6. The purpose of this process is to eliminate all traces of a user session on the device so that if it is a rental device, it will be ready for another user and the previous user's privacy will have been protected. The device has some auto shutdown features as well. If the user does not interact with it for longer than a user-specified or default amount of time, then the device will go into sleep mode. To reactivate the device from sleep mode, the user will have to go through a Biometric Identity Scan. If the device is left unused for longer than the sleep window, also specified by the user (or the default setting on the device), then the device will execute the Smart-Erase Shutdown Process.

IN step 602 of the Smart-Ease Shutdown Process 600 (FIG. 6), the user presses the “ON/OFF” button to terminate the user session and turn off the device. The device asks the user if he wants to update his profile on the main server to reflect the changes made to the PUM Card profile (step 604). A “No” response from the user (step 606) results in the device initiating step 618. A “Yes” response results in the device requesting a Biometric Identity Scan to authenticate the user's ownership of the PUM Card (step 608). If authentication fails (step 612), the device skips to step 620. After authentication (step 610), the device gives the user the options either of saving the PUM Card profile in a separate file for later review (step 614), or of overwriting the server profile (step 616). If the owner owns the device, he is asked if he wants keep the information on the device memory, and is asked to remove the PUM Card (step 618). If the device is a rental or if the owner-user opts to erase the device memory in step 618, if he owns the device, then the device memory and PUM Card, if left in the device, are erased (step 620). In step 622, the device terminates connection with the server and shuts down.

FIG. 1D shows an exemplary back view of the device shown in FIGS. 1A-1C. Contained in the back of the device are removable and upgradeable components, including a Central Process Unit (CPU) 17, a hard drive with read-Only Memory (ROM) 18, Random-Access Memory (RAM) and Cache 19, a a graphics component 20, an audio component 21, housing compartment for batteries 22, a retractable antenna 23A and wireless module 23B, a housing compartment for a PUM Card 15, and the Biometric Identity Scanner 16.

The device accepts a removable, replaceable, and upgradeable Central Processing Unit (CPU) 17 used for processing information received from a local server and for processing the user's interaction with the device. The variable characteristic of this wireless CPU is its processing speed in Megahertz One CPU can be replaced with another that possesses the same or higher processing speed, thus allowing the user greater processing speed and power.

The device also accepts a removable, replaceable, and upgradeable components such as a hard drive 1g, used for storing information received from a local server, such as application modules that allow the user to interact with a local area server. The viable characteristic of this wireless memory component is its memory capacity, such as Read-Only Memory (ROM). One memory component can be replaced with another that possesses the same or higher memory capacity, thus allowing the user more storage space for information downloaded from a local server.

Another component the device can accept is a removable, replaceable, and upgradeable wireless memory component used for storing information to speed up immediate access. The variable characteristic of this wireless memory component is its memory capacity, such as Random Access Memory (RAM) and Cache memory 19. One memory component can be replaced with another that possesses the same or higher memory capacity, thus allowing the user more storage space for information that requires immediate access, and therefore faster access to the information.

The graphics adapter 20, used for displaying graphical information received from a local server, is another removable, replaceable, and upgradeable component. The variable characteristic of this removable graphics adapter is its power to handle complex graphics. The removable, replaceable, and upgradeable audio driver 21 allows the user to customize the driver's power to handle complex audio input, including conversion of audio input into digital format for transmission as audio or text files, or as “packets” for internet telephony, or for transmission over cellular technology.

A battery housing compartment 22 is also positioned on the back of the device to receive a battery powering the device. The battery compartment stores a rechargeable or non-rechargeable battery or batteries to power the device.

The antenna 23A is retractable; When the device is powered up, the antenna 23A extends to its full length. Conversely, when the device is shut down by means of pressing a button such as the “ON/OFF” button, the antenna 23A retracts automatically. The wireless module 23B can be a Bluetooth module or an 802.11X module.

In Bluetooth wireless module embodiments, the Bluetooth wireless technology allows users to make effortless, wireless and instant connections between various communication devices, such as mobile phones and desktop and notebook computers. Since it uses radio transmission, transfer of both voice and data is in real-time. The sophisticated mode of transmission adopted in the Bluetooth specification ensures protection from interference and security of data. The Bluetooth radio is built into a small microchip and operates in a globally available frequency band ensuring communication compatibility worldwide. The Bluetooth specification has two power levels defined; a lower power level that covers the shorter personal area within a room, and a higher power level that can cover a medium range, such as within a home. Software controls and identity coding built into each microchip ensure that only those units preset by their owners can communicate. The Bluetooth wireless technology supports both point-to-point and point-to-multipoint connections. With the current specification, up to seven ‘slave’ devices can be set to communicate with a ‘master’ radio in one device. Several of these ‘piconets’ can be established and linked together in ad hoc ‘scatternets’ to allow communication among continually flexible configurations. AU devices in the same piconet have priority synchronization, but other devices can be set to enter at any time. The topology can best be described as a flexible, multiple piconet structure.

The Bluetooth module enables users to connect a wide range of computing and telecommunications devices easily and simply, without the need to buy, carry, or connect cables. It delivers opportunities for rapid ad hoc connections, and the possibility of automatic, unconscious, connections between devices. It will virtual eliminate the need to purchase additional or proprietary cabling to connect individual devices. Because Bluetooth wireless technology can be used for a variety of purposes, it will also potentially replace multiple cable connections via a single radio link.

For 802.11 embodiments such as 802.11b embodiments, the 802.11 standard provides MAC and PHY functionality for wireless connectivity of fixed, portable and moving stations moving at pedestrian and vehicular speeds within a local area The IEEE 802.11 standard specifies a wireless connectivity system that standardizes access to one or more frequency bands for local area communications. For customers, the benefit is interoperability between multiple vendor products. The standard defines three physical methods as well as two types of networking. The three different physical layer methods include two using radio frequency and one using infrared. The two radio physical layers operate in 2.4 GHz frequency range, one using frequency hopping spread spectrum (FHSS) and the other using direct sequence spread spectrum (DSSS). The one infrared physical layer operates using baseband infrared. Over the air data rates of 1 Mbps and 2 Mbps are defined in the standard. The IEEE 802.11 standard defines two types of networking, one being ad hoc networking and the other being infrastructure. An ad hoc network is a network composed solely of stations within mutual communication range of each other via the wireless medium. With ad hoc networking, the wireless clients communicate with to each other without the need for a wired network or access points. An infrastructure contains one or more access points which provide wireless clients with access to the wired network.

Besides the wireless module, the device also contains a housing compartment 15 for a removable, replaceable, and upgradeable Personal Universal Memory Card (PUM Card) (see FIG. 7). As described before, the PUM card is credit card sized and is used for storing user-produced information, such as profile information, preference information, e-mails, addresses, lists, calendar information, and so on. The variable characteristic of this wireless memory card is its memory capacity, such as Read-Only Memory (ROM). One memory card can be replaced with another that possesses a higher memory capacity, thus allowing the user more storage space for personal information which is used by the local area server to customize what the user experiences on the device. The PUM card can be removed and carried like a credit card and inserted into any device capable of accepting and reading it, such as an ATM machine, parking meter, toll booth, wireless telephones, pay phones etc. This is the “universal” feature of the card. In one embodiment, the user can slide the PUM card into the device and remove it immediately thereafter. Some customers will not want to insert their card and leave it in the device for fear of forgetting it. The “swipe” method allows for their comfort. However, the device will alert them to slide it again if needed.

Because the PUM card can be removed from a device and ported anywhere, Consumers do not have to carry the device with them The device can be made available to the user at a vendor site, either for loan or rent, and the user can slid his PUM Card into the PUM Card slot and customize the device for his use. Consumes can also purchase their own devices and upgrade them as needed.

FIG. 7 shows the front and back view of a PUM Card. The PUM Card can be obtained at any vendor who carries them and is available for free at its most basic level. It comes with cryptographic information for transport security. Personalization of the card stats with inserting it into a device and pressing the “ON/OFF” button. When the device detects a “blank” PUM card, it initiates a registration process through which the user can personalize the card. During personalization, the user is asked to scan their fingerprint using the built-in Biometric Identity Scanner 15, and is also asked to enter various personal identification and preference information. The PUM card can contain data that uniquely identifies the user. For example, the personalization data can include personal profile information including name, login id, passwords, address, phone numbers, bank information, credit level etc., and consumer preference information such as preferred websites, stores, brand names, size of clothing, music, software, games. The data will also include biometric data to authenticate the user. The biometric data can include fingerprint scan, retina scan, voice identification, or other biometric data that the processor can compare against in real-time. A PUM Card can be shared by more than one user. The identities and personal profile and preference information are kept separate.

Three processes that depend on a user's personal preference information stored on the PUM card are the Configuration-Dependent Download Process (see FIG. 2), the Private Communication Process for “Pulling” Information (see FIG. 4A), and the Private Communication Process for “Pushing” Information (see FIG. 4B). These processes have been described above.

As mentioned earlier, the Configuration-Dependent Download Process ensues the efficient operation of the device. This feature prompts application developers to program different versions of an application for differently configured devices, or “turn off” features for efficient use on a device, or configure modules for download that will work efficiently on the device. Users can also purchase and “snap-on” new components such as an upgraded Read-Only memory component.

Without the PUM Card, The device is virtually disposable because its utility as a tool for personalizing the wireless experience, whether it be for shopping, giving feedback, insanity receiving stock information, making travel arrangements, and so on, is limited without the PUM card. The PUM Card is the user's tool for personalized convenience in the wireless world, and processes such as the Configuration-Dependent Download Process (see FIG. 2), the Private Communication Process for “Pulling” Information (see FIG. 4A), and the Private Communication Process for “Pushing” Information (see FIG. 4B) aid the user personalizing their experience.

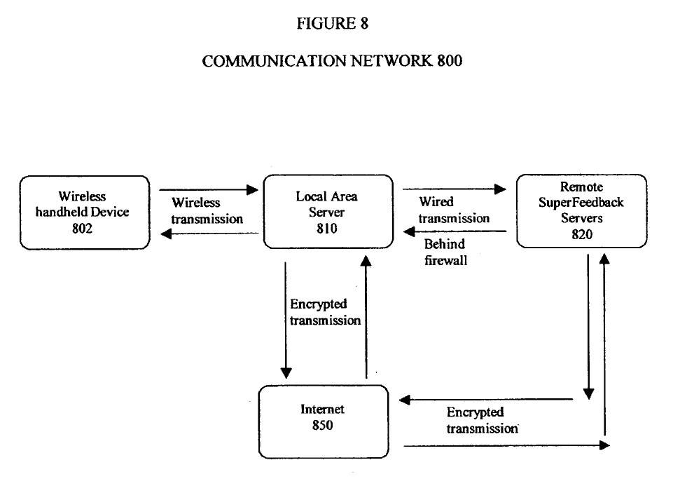

FIG. 8 shows an exemplary network supporting the wireless device of FIGS. 1A-1D. The network includes one or more wireless handheld devices 802 that wirelessly communicate with a local area server 810. The local area server 810 in turn communicates over a firewall with one or more remote servers 820. The local area server 810 and the remote servers 820 communicate over a wide area network 850 such as the Internet.

The server 810 is protected by a firewall. When the firewall receives a network packet from the remote servers 820, it determines whether the transmission is authorized. If so, the firewall examines the header within the packet to determine what encryption algorithm was used to encrypt the packet. Using this algorithm and a secret key, the firewall decrypts the data and addresses of the source and destination fireballs and sends the data to the server 810. If both the source and destination are firewalls, the only addresses visible (i.e., unencrypted) on the network are those of the firewall. The addresses of computers on the internal networks, and, hence, the internal network topology, are hidden This is called “virtual private networking” (VPN).

The server 810 provides a single point of integration, access, and navigation through the multiple enterprise systems and information sources facing knowledgeable users operating the client handheld devices 802. The portal can additionally support services that are transaction driven. Once such service is advertising: each time the user accesses the portal, the client handheld device 802 downloads information from the server 810. The information can contain commercial messages/links or can contain downloadable software that contains codes matching those on the PUM Card. Based on user preference codes, banner advertisements with matching codes can be displayed in the user's device. A user can click on the image and be routed to an advertiser's Web-site or retrieve more information from the server linked to the banner advertisement. Advertisers pay for the number of advertisements accessed by users, the number of times users click on advertisements, or based on other criteria. Alternatively, the portal supports sponsorship programs, which involve providing an advertiser the right to be displayed on the face of the port or on a drop down menu for a specified period of time, usually one year or less. The portal also supports performance-based arrangements whose payments are dependent on the success of an advertising campaign, which may be measured by the number of times users visit a Web-site, purchase products or register for services. The portal can refer users to advertisers' Web-sites when they log on to the portal.

Other services can be supported as we& For example, a vendor can rent space on the server to host their applications or advertisements for user access. Thus, applications will be stored on the server instead of on the handheld device, and will be accessible by users. By off-loading the storage on the server, the user minimizes the memory required on the client handheld device 802, thus enabling complex operations to run on minimal computers such as handheld computers and yet still ensures that he/she can access the application and related information anywhere anytime.

Another service is On-line Software Distribution/Rental Service. The portal can distribute its software and other software companies from its server. Additionally, the portal can rent the software so that the user pays only for the actual usage of the software. After each use, the application is erased and will be reloaded when next needed, after paying another transaction usage fee.

The device as described above is component based and its value will be determined by the sum of its removable, replaceable, and upgradeable parts, it will be a versatile instrument, the configuration of which can be customized to meet the usability needs and price point of the purchaser. The least expensive model will be virtually disposable, but reusable. As a result, vendors who purchase these devices for their customers can purchase the least expensive version with components appropriate to their price level and function they want the device to perform; vendors in malls can rent the equipment at different price levels based on the component configuration chosen by customers and the functionality they desire. The device can be used to “pull” featured sales to consumers based on their preference profile stored on their PUM card. This can take place at malls, airports, train stations, grocery stores, or at the location of any vendor. The device can be used to obtain feedback about a consumer's experience with a vendor. Further, the device can be used to collect data on behaviors and tasks that employees must complete in-house.

Moreover, users who obtain these devices can purchase components separately for upgrading whatever part they want to at a price point their budget will allow to obtain the level of functionality they choose to have access to. For example, to use the telephony features of the device, the user may need to upgrade their modem and RAM components to higher levels. The disposable shell, consisting of just the screen, and buttons and other embedded components, allows users to purchase a shell of their choice at an inexpensive price and retain the components that came with the original device. Users may want to purchase a new shell because they want a different look, or because a new display technology has become available. The device can be used to conduct transactions using online transaction-vendors like www.PayPal.com. The device can be used for Internet Telephony through vendors such as www.Iconnecthere.com and www.Net2phonedirect.com. The device can be used to send instant messages to others with the device, via compressed audio files, or text based messaging.

Application developers can design applications for different levels of hardware configuration of the device and push their application for that platform and inform the user that either the more sophisticated version of their application is available, or that additional application features will become available, if they upgrade their hardware.

Portability of the device allows consumers to give feedback at the point of service provided a local server is nearby. The ability to give feedback at the point of service to an independent agency will increase the number of consumers actually giving feedback. Currently, statistics show that 90+% of consumers do not give feedback. This amounts to many lost opportunities for vendors to address issues, which when addressed, can rescue customer confidence and loyalty.

The device supports easy data collection while satisfying privacy issues relating to personal information and preferences of the consumer. The device protects this information by reading the PUM card for preferences and then reading what advertisements are available on the local server based on a predetermined code. If the code matches, the device will “pull” the relevant ad to the device for the user to view. No personal information is sent to the local server. This same method can be used at all other electronic devices the card is used in. The device “pulls” relevant information from a device or activates a device based on synchronization of codes.

The compact, portable wireless communication device can be used in a wide range of industries, government organizations, and functions, and include, but are not limited to, the following:

Transportation and Travel Industry. More and more people travel each year, whether by rental car, plane, taxi, bus, boat, or train. The potential for impacting the service in that industry is huge. At the most basic level, a customer will be able to give a taxi driver feedback via the device and be able to calculate the tip they should give based on the service received.

Government. Again, the implications for consumer participation in improving government services are phenomenal Citizen participation in issues regarding legislation is also possible with this device. The device can be used in the armed forces for communication and verification of information; in the police department for verifying drivers' license information or finger prints without having to call; in schools for education . . . learning games can be run on the device by children, and so on.

Global Commerce. Many US companies have global operations, such as companies in the fast food industry. Understanding the preferences of local customer is a must for being successful. Many companies help large corporations establish a global Internet presence and their primary concern is whether the website caters to the local population's tastes. Consumers need access to something that is easy to use and takes very little time to give feedback. This device can help.

Advertising over the Internet has gone through many changes. All along, however, the challenge has been to target advertising to consumers who will respond to them. The core issue in this challenge is that of relevance to the consumer. This device will allow consumers to specify their preferences at the point of service, therefore, providing the information necessary to make advertising relevant to the individual. This will be very useful at malls where a consumer who enters the mall and specifies the categories of items s/he is looking for, can “pull” relevant advertisements from mall vendors to his or her device. The same is true of food items in a restaurant, or travel specials at airports, travel agencies, rides at theme parks, and so on. This device, combined with software, will revolutionize targeted advertising and bring value to vendors where previously that value was questionable with companies like www.DoubleClick.com.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A method for downloading data from a server to a computer, comprising:
accessing user preferences from a Personal Universal Memory (PUM) card;
transmitting user preference and computer configuration information to the server;
determining applications that can be supported by the computer configuration; and
downloading only supported applications to the computer.

2. The method of claim 1, further comprising assigning a code to the application when a vendor subscribes to the service for hosting the application on the local server.

3. The method of claim 1, further comprising selecting one or more applications when the user configures the user preference.

4. The method of claim 1, further comprising storing codes for the selected applications on the PUM card.

5. The method of claim 1, further comprising selecting one or more applications when the user configures the user preference.

6. The method of claim 1, further comprising authenticating the user.

7. The method of claim 1, further comprising performing a biometric scan to identify the user.

8. The method of claim 1, further comprising checking for a match between a scanned image and a user identifiable image stored on the PUM card.

9. The method of claim 1, further comprising requesting a user-identification and a password

10. The method of claim 1, further comprising checking the user's preferences on the PUM card to identify applications to be downloaded during startup.

11. The method of claim 1, further comprising sending a packet from the computer to the local server including:
a. codes identifying the computer configuration; and
b. codes identifying user-preferred applications.

12. The method of claim 11, further comprising requesting codes of applications and application components on the server that match the codes for user-preferred applications sent by the computer.

13. The method of claim 11, further comprising requesting codes of applications and application components on the server that match the codes for non-supported user-preferred applications sent by the computer.

14. The method of claim 13, further comprising requesting information about the computer configuration necessary to support the applications and application components.

15. The method of claim 11, further comprising requesting codes of applications and application components on the server that are supported by the computer's configuration.

16. The method of claim 11, further comprising notifying the user that one or more requested applications cannot be supported without upgrading the computer hardware.

17. The method of claim 11, further comprising giving the user options to abort the download or to select applications supported by the computer for download.

18. The method of claim 11, further comprising downloading items selected by user if the user opts to download supported applications and application components.

19. The method of claim 11, further comprising scanning all data being downloaded to the computer with anti-virus software.

20. The method of claim 11, wherein the anti-virus software is automatically updated upon initial connection with the server.

21. The method of claim 11, wherein the computer is selected from one of the following: a wired device, a wireless device, a personal digital assistant, a handheld computer, a laptop computer and a cellular telephone.

22. A method for downloading data from a server to a computer, comprising:
accessing user preferences;
transmitting user preference and computer configuration information to the server;
determining applications that can be supported by the computer configuration; and
downloading only supported applications to the computer.
